(19) United States
(12) Patent Application Publication
(10) Pub. No.: US 2004/0101266 A1
(43) Pub. Date: May 27, 2004

(54) Pneumatically actuated bottom mounted device gripper with quick change tooling jaws

(76) Inventors: Victor Kardos, Irvine, CA (US); Randy Heyler, Newport Beach, CA (US); Gary Rangel-Freidman, Laguna Niguel, CA (US); Brian Evans, Marshfield, MA (US)

Correspondence Address: IRELL & MANELLA LLP, 840 NEWPORT CENTER DRIVE, SUITE 400, NEWPORT BEACH, CA, 92660, US

(21) Appl. No.: 10/302,345

(22) Filed: Nov. 22, 2002

(51) Int. Cl. G02B 6/00

(52) U.S. Cl. 385/136

(57) ABSTRACT

a gripper that can grasp an optical device. The gripper includes a jaw assembly coupled to a platform. The jaw assembly can be actuated by a fluid powered actuator to grasp a device. The fluid powered actuator may be a pneumatic cylinder. The actuator can be coupled to a pressure regulator that regulates the force exerted by the jaw assembly onto the device. The gripper may also have a speed regulator that regulates the speed of the jaw assembly. The jaw assembly may include a first jaw and a movable second jaw. The gripper jaws are coupled to the platform by fasteners in a manner that allows for interchangeability of the jaws.

### BACKGROUND OF THE INVENTION

1. Field of the Invention

The subject matter disclosed generally relates to an automated gripper that can grasp an optical device such as a fiber optic cable.

2. Background Information

Optical components such as fiber optic cables are typically terminated at an electronic package or other structure. It is desirable to automate the process of attaching the cable to the package. Automation is generally cheaper and less prone to human error than manual processes.

Automated equipment used to process and assemble optical devices typically include a gripper that holds the device. The gripper may include a stationary jaw and a movable gripper jaw. The movable jaw is typically coupled to a spring that can exert a force onto the device.

The gripper jaw is moved between an open position which allows the optical device to be loaded into the gripper and a closed position which secures the device. Movement of the gripper jaw is a manual operation that requires a human operator, thereby limiting the automation of the process. Manual operation of the gripper is also subject to varying clamping forces and different clamping speeds. Closing the jaw too fast and too hard may damage the device.

The gripper jaws are configured to optimally hold one type of part. The grippers may not readily grasp another part that has a different size. For example, a gripper may be designed and constructed to hold a fiber optic cable with a certain outer diameter. Inserting a smaller cable may result in a lower spring grasping force, because the spring coupled to the movable jaw does not have as great of a deflection. The lower grasping force may allow undesirable movement of the cable during the attachment process. Additionally, a device with a different shape may not fit within a specific type of gripper. For example, a rectangular shaped device may not fit within a gripper configured for a cylindrical device such as a fiber optic cable.

### BRIEF SUMMARY OF THE INVENTION

A gripper for holding an optical device that has a fluid powered actuator coupled to a jaw assembly. The jaw assembly holds the device and is coupled to a platform.

### BRIEF DESCRIPTION OF THE DRAWINGS

FIG. 1 is a perspective view of a gripper that holds an optical device;

FIG. 2 is a schematic of the gripper;

FIG. 3 is a side view showing an optical device grasped by a jaw assembly;

FIG. 4 is a side view showing an alternative jaw assembly gripping a different device.

### DETAILED DESCRIPTION

Disclosed is a gripper that can grasp an optical device. The gripper includes a jaw assembly coupled to a platform. The jaw assembly can be actuated by a fluid powered actuator to grasp a device. The fluid powered actuator may be a pneumatic cylinder. The actuator can be coupled to a pressure regulator that regulates the force exerted by the jaw assembly onto the device. The gripper may also have a speed regulator that regulates the speed of the jaw assembly. The jaw assembly may include a first jaw and a movable second jaw. The gripper jaws are coupled to the platform by fasteners in a manner that allows for interchangeability of the jaws.

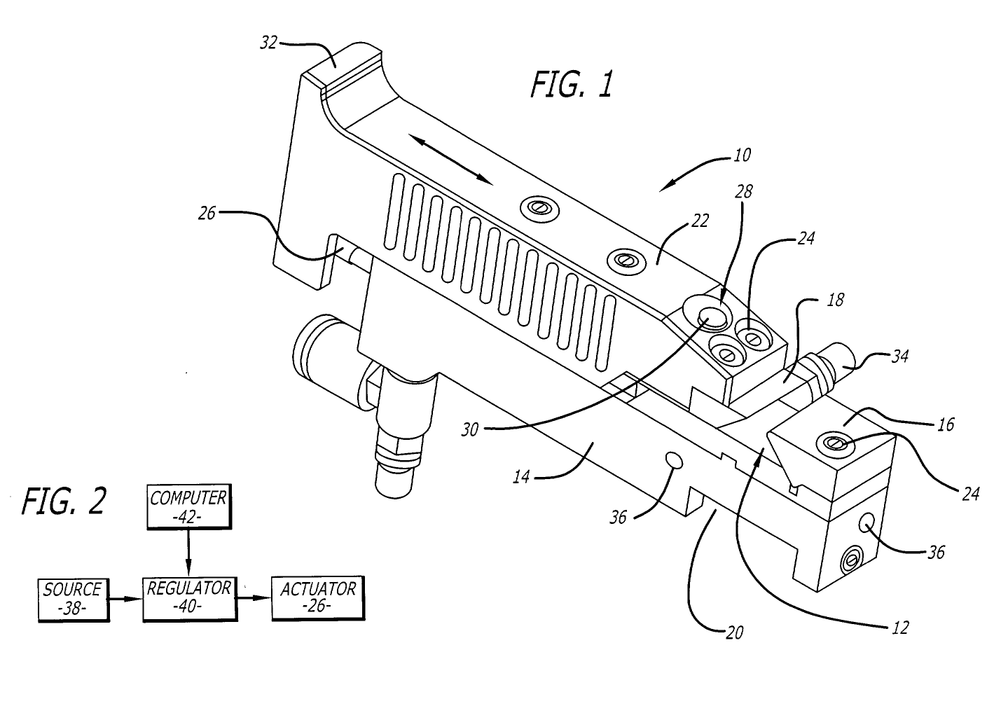

Referring to the drawings more particularly by reference numbers, FIG. 1 shows a gripper 10. The gripper 10 may include a jaw assembly 12 that is mounted to a platform 14. The jaw assembly 12 may include a first stationary jaw 16 and a second movable jaw 18. The platform 14 may include a dovetail groove 20 that allows the gripper 10 to be mounted to, and move on, an automated machine (not shown).

The second jaw 18 may be connected to a linear bearing assembly 22. The linear bearing 22 allows linear movement of the second jaw 18 along the platform 14. The jaws 16 and 18 are preferably connected to the platform 14 by fasteners 24. The fasteners 24 allow for interchangeability of the jaws 16 and 18.

The linear bearing 22 and second jaw 18 may be coupled to a fluid powered actuator 26. By way of example, the fluid powered actuator 26 may be a pneumatic cylinder. The actuator 26 can be actuated to automatically move the second jaw 18 between an open position and a closed position. The second jaw 18 may also be manually moved by pushing the linear bearing 22. When operated manually the actuator 26 functions as a mechanical brake that limits the speed of the second jaw 18.

The linear bearing 22 may have a lock 28 that locks the position of the second jaw 18. The lock 28 may be switched between locked and unlocked positions by depressing a button 30. The linear bearing 22 may have a finger ridge 32 to facilitate the manual movement of the second jaw 18.

The gripper 10 may include a speed regulator 34 that is coupled to the actuator 26. The speed regulator 34 may be a flow restrictor that limits the flow of air into the actuator 26 and the speed of the second jaw 18. The speed regulator 34 may be attached to one of a plurality of speed control openings 36. The various openings 36 allow for different gripper 10 configuration.

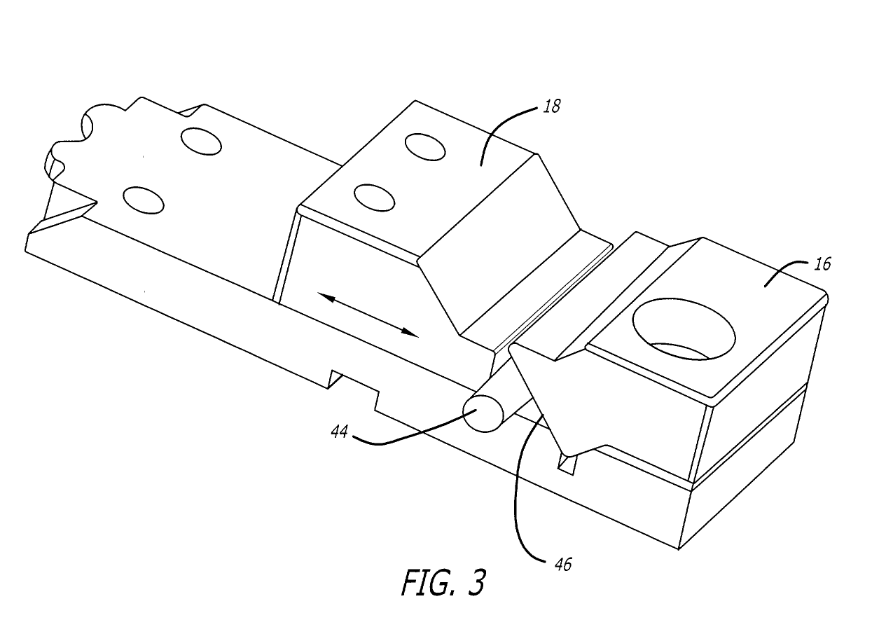

As shown in FIG. 2, the actuator 26 may be coupled to a source of pressurized air 38 and a pressure regulator 40. The source of pressurized air 38 may be an air supply in the wall of a commercial facility. The pressure regulator 40 regulates the pressure of the air within the actuator 26 and the resultant force exerted by the second jaw 18. The pressure regulator 40 may be connected to a computer 42 that allows an operator to vary the pressure and resultant force exerted by the second jaw 18.

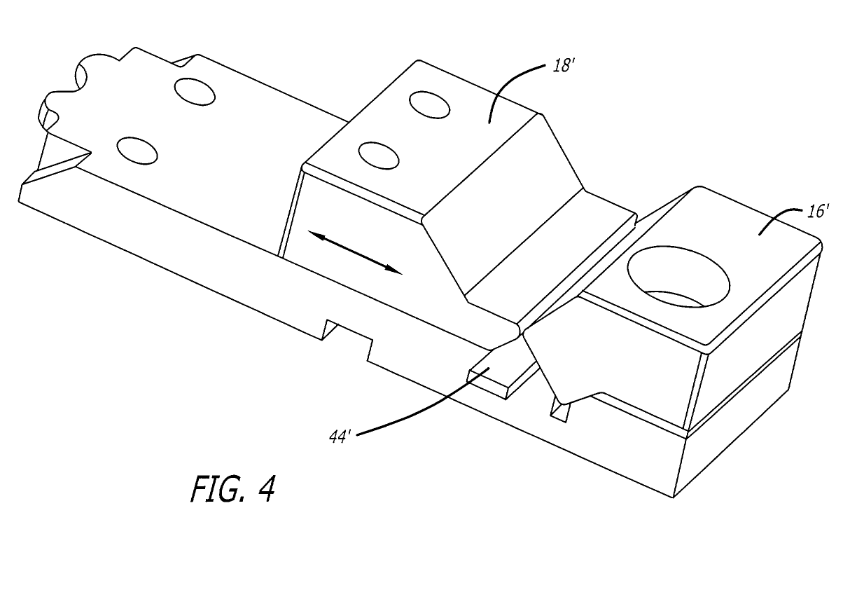

As shown in FIG. 3, the second jaw 18 may be moved to press an optical device 44 into the first jaw 16 and grasp the device 44. The first jaw 16 may have a tapered surface 46 to compensate for different diameters of the optical device 44.

As shown in FIG. 4, different jaws 16′ and 18′ may be interchanged into the gripper 10. The jaws 16′ and 18′ are each configured to more readily grasp a rectangular device 44′. The fasteners allow the jaws to be readily changed to accommodate different types of devices.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A gripper for gripping an optical device, comprising:
a platform;
a jaw assembly coupled to said platform; and,
a fluid powered actuator coupled to said jaw assembly.

2. The gripper of claim 1, wherein said fluid powered actuator is a pneumatic cylinder.

3. The gripper of claim 1, further comprising a pressure regulator coupled to said fluid powered actuator.

4. The gripper of claim 3, further comprising a computer coupled to said pressure regulator.

5. The gripper of claim 1, further comprising a speed regulator coupled to said jaw assembly.

6. The gripper of claim 1, wherein said jaw assembly includes a first jaw that is attached to said platform by a first fastener and a second jaw that is coupled to said fluid powered actuator by a second fastener.

7. The gripper of claim 6, wherein said first jaw has a tapered surface.

8. The gripper of claim 5, wherein said speed regulator includes a flow restrictor.

9. The gripper of claim 6, further comprising a linear bearing that couples said second jaw to said platform.

10. The gripper of claim 6, further comprising a lock coupled to said second jaw.

11. A gripper for gripping an optical device, comprising:
a platform;
gripper means for gripping the optical device; and,
actuator means for actuating said gripper means.

12. The gripper of claim 11, wherein said actuator means includes a pneumatic cylinder.

13. The gripper of claim 11, further comprising pressure regulator means for regulating a force exerted by said gripper means.

14. The gripper of claim 13, further comprising computer means for varying the force exerted by said gripper means.

15. The gripper of claim 11, further comprising speed regulator means for regulating a speed of said gripper means.

16. The gripper of claim 11, wherein said gripper means includes a first jaw that is attached to said platform by a first fastener and a second jaw that is coupled to said actuator means by a second fastener.

17. The gripper of claim 16, wherein said first jaw has a tapered surface.

18. The gripper of claim 15, wherein said speed regulator means includes a flow restrictor.

19. The gripper of claim 16, further comprising a linear bearing that couples said second jaw to said platform.

20. The gripper of claim 16, further comprising a lock coupled to said second jaw.

21. A method for gripping an optical device, comprising:
placing an optical device adjacent to a first jaw and a second jaw;
actuating an fluid powered actuator to move the second jaw into contact with the optical device.

22. The method of claim 21, further comprising changing the first and second jaws.

23. The method of claim 21, further comprising regulating a force exerted by the second jaw onto the optical device.

24. The method of claim 21, further comprising regulating a speed at which the second jaw moves into the optical device.

25. The method of claim 23, further comprising varying the force that is exerted by the second jaw.
